(19) United States
(12) Patent Application Publication
(10) Pub. No.: US 2017/0284558 A1
(43) Pub. Date: Oct. 5, 2017

(54) SOLENOID VALVE

(71) Applicant: Hyundai Motor Company, Seoul (KR)

(72) Inventors: June Ho LEE, Seoul (KR); Youngchul KIM, Gwangmyeong-si (KR)

(73) Assignee: Hyundai Motor Company, Seoul (KR)

(21) Appl. No.: 15/267,573

(22) Filed: Sep. 16, 2016

(30) Foreign Application Priority Data
Mar. 29, 2016 (KR) 10-2016-0037480

(51) Int. Cl. F16K 31/08; F16K 11/07; B03C 1/033; F16K 31/06

(52) U.S. Cl. CPC F16K 31/082; F16K 31/0613; F16K 11/07; B03C 1/0332; B03C 1/0335

(57) ABSTRACT

A solenoid valve may include a magnetic force generating coil applied with power to generate an electromagnetic force, a valve spool disposed to reciprocate depending on the electromagnetic force generated from the magnetic force generating coil, a holder including a hollow into which the valve spool inserted, the holder forming a plurality of ports to be opened and closed depending on the reciprocating of the valve spool, and a permanent magnet disposed to enclose the hollow of the holder.

### CROSS-REFERENCE TO RELATED APPLICATION

The present application claims priority to Korean Patent Application No. 10-2016-0037480, filed Mar. 29, 2016, the entire contents of which is incorporated herein for all purposes by this reference.

### BACKGROUND OF THE INVENTION

### Field of the Invention

The present invention relates to a solenoid valve, and more particularly, to a solenoid valve capable of preventing an internal pressure from rising.

### Description of Related Art

Generally, a solenoid valve is mainly categorized into a hydraulic pressure solenoid valve used in a hydraulic circuit, an air solenoid valve used in an pneumatic circuit, a solenoid valve merely using an electromagnetic force, or the like.

Among those, the hydraulic pressure solenoid valve controls a flow of a hydraulic pressure generated from a hydraulic pressure pump to start, stop, change a motion direction of an operating device, or the like.

For example, the hydraulic pressure solenoid valve may be used in the operating devices such as an automatic transmission of a vehicle. The automatic transmission includes a plurality of friction elements such as a clutch and a brake operated by the hydraulic pressure to implement various shift stages. That is, the hydraulic pressure solenoid valve controls an operation of the friction elements. In particular, when the hydraulic pressure solenoid valve is installed at an engine clutch of a hybrid vehicle, an operation of the hydraulic pressure solenoid valve determines basic performance of the hybrid vehicle selectively connecting an engine and a motor.

However, when foreign materials introduced into the solenoid valve affect an internal pressure of the solenoid valve, automatic transmission performance of the engine-driven vehicle or the hybrid vehicle may deteriorate. The deterioration in performance of the automatic transmission has an adverse effect on driver satisfaction and may cause a severe accident.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a solenoid valve having advantages of preventing an internal pressure from excessively rising due to foreign materials.

According to various aspects of the present invention, a solenoid valve may include a magnetic force generating coil applied with power to generate an electromagnetic force, a valve spool disposed to reciprocate depending on the electromagnetic force generated from the magnetic force generating coil, a holder including a hollow into which the valve spool inserted, the holder forming a plurality of ports to be opened and closed depending on the reciprocating of the valve spool, and a permanent magnet disposed to enclose the hollow of the holder.

The permanent magnet may be disposed spaced apart from the hollow of the holder at a predetermined distance.

The permanent magnet may form a non-uniform magnetic field as the valve spool reciprocates.

The permanent magnet may form a uniform magnetic field as the reciprocating of the valve spool stops.

The plurality of ports may include an oil inlet port to supply oil into the holder, and selectively opened and closed depending on the reciprocating of the valve spool, an oil outlet port to discharge the oil in the holder and selectively opened and closed depending on the reciprocating of the valve spool, and a control port continuously open to discharge the oil supplied through the oil inlet port, in which as a magnetic force of the permanent magnet in the uniform magnetic field of the permanent magnet is reduced, a foreign material, of an iron component collected in an inner circumferential surface of the hollow of the holder by the magnetic force of the permanent magnet in the non-uniform magnetic field of the permanent magnet, may be discharged through the oil outlet port, together with the oil.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a solenoid valve according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

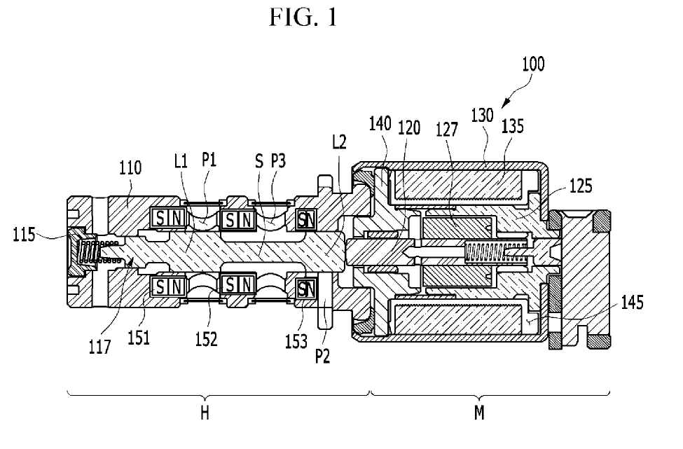

FIG. 1 is a schematic diagram of a solenoid valve according to various embodiments of the present invention.

As illustrated in FIG. 1, a solenoid valve 100 according to various embodiments of the present invention includes a holder member H, a magnetic member M, and a core part 140 forming a boundary between the holder member H and the magnetic member M.

The holder member H includes a holder 110 and a valve spool 117.

The holder 110 is a valve body of the holder member H and has a hollow cylindrical shape. Further, the holder 110 is provided with a plurality of ports P1, P2, and P3. The plurality of ports P1, P2, and P3 are formed to penetrate through the holder 110 to communicate an inside and an outside of the holder 110 with each other.

The valve spool 117 is inserted into a hollow of the holder 110 to be reciprocated along a length direction of the holder 110. The valve spool 117 includes a first land L1 and a second land L2 that are inserted into an inner circumferential surface of the holder 110 with little space and a spool shaft S formed to be relatively thinner than the first and second lands L1 and L2 to connect the first land L1 and the second land L2. Further, an elastic member 115 is disposed between one end of the valve spool 117 and an inner surface of the holder 110 to press against the valve spool 117 to one side in a length direction of the holder 110. The other end of the valve spool 117 extends towards the core part 140.

The plurality of ports P1, P2, and P3 include an oil inlet port P1, an oil outlet port P2, and a control port P3.

The oil inlet port P1 is selectively opened and closed depending on the reciprocating motion of the valve spool 117. Therefore, the oil inlet port P1 selectively communicates with a space between the first land L1 and the second land L2. Here, the oil inlet port P1 is closed by the first land L1. Meanwhile, the first land L1 is relatively closer than the second land L2 to one end of the valve spool 117. When the oil inlet port P1 communicates with the space between the first land L1 and the second land L2, oil is introduced into the space between the first land L1 and the second land L2 through the oil inlet port P1.

The oil outlet port P2 is selectively opened and closed depending on the reciprocating motion of the valve spool 117. Therefore, the oil outlet port P2 selectively communicates with the space between the first land L1 and the second land L2. Further, the oil outlet port P2 is closed by the second land L2. When the oil outlet port P2 communicates with the space between the first land L1 and the second land L2, oil in the space between the first land L1 and the second land L2 is discharged through the oil outlet port P2. Meanwhile, when the space between the first land L1 and second land L2 and the oil outlet port P2 communicate with each other, the oil inlet port P1 is closed by the first land L1. Here, the second land L2 is disposed at the other end of the valve spool 117 and the oil outlet port P2 is disposed to be adjacent to the core part 140.

The control port P3 continuously communicates with the space between the first land L1 and the second land L2. Therefore, the oil introduced into the oil inlet port P1 is discharged to the control port P3 via the space between the first land L1 and the second land L2 of the valve spool 117. The oil discharged to the control port P3 is supplied to control hydraulic equipment communicated with the control port P3. Meanwhile, the oil discharged through the oil outlet port P2 is the remaining oil that is not discharged through the control port P3.

The magnetic member M is a member that generates an electromagnetic force and includes a case 130, a magnetic force generating coil 135, a plunger 120, and a discharge channel 145.

The case 130 is a valve body of the magnetic member M and has a hollow cylindrical shape.

The magnetic force generating coil 135 is disposed on an inner circumferential surface of the case 130. The magnetic force generating coil 135 is applied with power to generate an electromagnetic force.

The plunger 120 is disposed to be reciprocated along a length direction of the case 130. The plunger 120 is integrally disposed with a core 127 enclosed with a yoke 125 in the hollow of the magnetic force generating coil 135. That is, when the magnetic force generating coil 135 is applied with power to generate the electromagnetic force, the plunger 120 longitudinally moves along with the core 127. In this case, one end of the plunger 120 penetrates through the core member 140 to contact the other end of the valve spool 117 and the plunger 120 pushes the other end of the valve spool 117 toward one end thereof by the electromagnetic force generated by the magnetic force generating coil 135. Therefore, the oil inlet port P1 is opened by the electromagnetic force generated by the magnetic force generating coil 135 and when the electromagnetic force is released, the valve spool 117 returns to an original position to close the oil inlet port P1 by the elastic member 115.

The discharge channel 145 is a channel that is formed to discharge oil infiltrated into the hollow of the magnetic force generating coil 135 from the hollow of the holder 110 to outside through the core part 140.

However, when foreign material of an iron component infiltrated into the hollow of the holder 110 is increased, the foreign material of the iron component having a large specific gravity is not discharged through the oil outlet port P2, and therefore the internal pressure of the hollow of the holder 110 is increased. Further, the foreign material of the iron component having a large specific gravity overflows into the hollow of the magnetic force generating coil 135 due to the increased internal pressure of the hollow of the holder 110, and therefore the interference of the electromagnetic force generated from the magnetic force generating coil 135 is caused, such that operation performance of the plunger 120 may be reduced.

Hereinafter, a configuration according to various embodiments of the present invention for solving the problem will be described.

The solenoid valve 100 according to various embodiments of the present invention further includes permanent magnets 151, 152, and 153.

FIG. 1 illustrates three permanent magnets 151, 152, and 153 that are first, second, and third permanent magnets 151, 152, and 153, but the number of permanent magnets is not limited thereto. Therefore, a plurality of permanent magnets may be provided according to a design by a person having ordinary skill in the art (hereinafter, those skilled in the art).

The first permanent magnet 151 is disposed at one end of the valve spool 117 with respect to the oil inlet port P1.

The second permanent magnet 152 is disposed between the oil inlet port P1 and the control port P3.

The third permanent magnet 153 is disposed between the control port P3 and the oil outlet pot P2.

The first, second, and third permanent magnets 151, 152, and 153 are disposed in the holder 110 to enclose the hollow of the holder 110. That is, the first, second, third permanent magnets 151, 152, and 153 are embedded in a body of the holder 110. Further, the first, second, third permanent magnets 151, 152, and 153 generate a non-uniform magnetic field as the valve spool 117 is reciprocated. Further, the first, second, and third permanent magnets 151, 152, and 153 are disposed to be spaced apart from the hollow of the holder 110 at a predetermined distance so that the amount of magnetic force in the uniform magnetic field stopping the valve spool 117 that has an effect on the hollow of the holder 110 becomes a set value.

Therefore, the foreign material of the iron component contained in the oil introduced into the hollow of the holder 110 is collected in the inner circumferential surface of the holder 110 by the magnetic force of the first, second, and third permanent magnets 151, 152, and 153 in the non-uniform magnetic field due to the reciprocating motion of the valve spool 117. Further, the magnetic force of first, second, and third permanent magnets 151, 152, and 153 in the uniform magnetic field stopping the reciprocating motion of the valve spool 117 is reduced, such that the foreign material of the iron component collected in the inner circumferential surface of the holder 110 is separated from the inner circumferential surface of the holder 110. Further, the foreign material of the iron component separated from the inner circumferential surface of the holder 110 is discharged to the outside through the oil outlet port P2, together with oil.

The collection and the separation of the foreign material due to the difference in the magnetic force between the non-uniform magnetic field and the uniform magnetic field use a magnetic confinement effect, which is apparent to those skilled in the art.

As described above, according to various embodiments of the present invention, the permanent magnets 151, 152, and 153 are disposed on the circumference of the hollow of the holder 110, such that the foreign material in the solenoid valve 100 sticks to the inner circumferential surface of the holder 110, thereby smoothing the flow of oil. Therefore, it is possible to prevent the internal pressure from excessively rising. The foreign material separated from the inner circumferential surface of the holder 110 due to the difference in the magnetic force of the permanent magnets 151, 152, and 153 in the non-uniform magnetic field due to the reciprocating motion of the valve spool 117 and in the uniform magnetic field due to the stop of the valve spool 117 is discharged to the oil outlet port P2, together with oil, thereby securing the performance of the solenoid valve 100.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A solenoid valve, comprising:
a magnetic force generating coil applied with power to generate an electromagnetic force;
a valve spool disposed to reciprocate depending on the electromagnetic force generated from the magnetic force generating coil;
a holder including a hollow into which the valve spool inserted, the holder forming a plurality of ports to be opened and closed depending on the reciprocating of the valve spool; and
a permanent magnet disposed to enclose the hollow of the holder.

2. The solenoid valve of claim 1, wherein the permanent magnet is disposed spaced apart from the hollow of the holder at a predetermined distance.

3. The solenoid valve of claim 1, wherein the permanent magnet forms a non-uniform magnetic field as the valve spool reciprocates.

4. The solenoid valve of claim 3, wherein the permanent magnet forms a uniform magnetic field as the reciprocating of the valve spool stops.

5. The solenoid valve of claim 4, wherein the plurality of ports include:
an oil inlet port to supply oil into the holder, and selectively opened and closed depending on the reciprocating of the valve spool;
an oil outlet port to discharge the oil in the holder and selectively opened and closed depending on the reciprocating of the valve spool; and
a control port continuously open to discharge the oil supplied through the oil inlet port,
wherein as a magnetic force of the permanent magnet in the uniform magnetic field of the permanent magnet is reduced, a foreign material, of an iron component collected in an inner circumferential surface of the hollow of the holder by the magnetic force of the permanent magnet in the non-uniform magnetic field of the permanent magnet, is discharged through the oil outlet port, together with the oil.
